(19) United States
(12) Patent Application Publication
(10) Pub. No.: US 2011/0097545 A1
(43) Pub. Date: Apr. 28, 2011

(54) METHOD OF CONTROLLING RESOLUTION IN INKJET PRINTING

(75) Inventors: Jochen Bossuyt, Tiegem (BE); Francois Rummens, Bruxelles (BE); Robert Francescutti, Neuhofen (DE)

(73) Assignee: RENOLIT AG

(21) Appl. No.: 12/746,809

(22) PCT Filed: Nov. 21, 2008
(86) PCT No.: PCT/EP08/09886

§ 371 Date: Jan. 3, 2011

(30) Foreign Application Priority Data
Dec. 14, 2007 (EP) 07024254.0

(51) Int. Cl. B41M 5/52; B29C 59/02; B29C 43/24

(52) U.S. Cl. 428/156; 264/284; 264/167

(57) ABSTRACT

The present invention relates to a method of manufacturing films as substrate in inkjet printing from a composition containing a polyvinyl chloride as polymeric base by admixing a filler coated with a polysiloxane and/or a polysiloxane wherein the composition manufactured into a film, the film is embossed and the film temperature during embossing is set to not more than 70° C. for high resolution and to at least 70° C. for printing large areas in uniform colour. The invention is also directed to the films obtained thereby.

The present invention relates to a method for controlling the flowing rate of organic based inks on PVC films for inkjet printing, and the films themselves.

Inkjet printing is a method of direct application of ink droplets on the surface of a substrate like polymeric films. It is easily adapted to control by computers. In contrast to the classical (conventional) printing technologies using contact between the substrate and printing devices (like cylinders or panels), during inkjet printing no such contact between the printing equipment and the substrate takes place. The obtained resolution depends directly on the fineness of the droplets and the precision with which their application is controlled.

For high resolution it is important that the droplets do not expand too much on the substrate to obtain a good resolution. The ratio between the diameter of the dried ink dot on the substrate and the original diameter of the applied droplet (“dot gain”) should be as low as possible to obtain a high resolution, preferably between 1.5 and 3. This problem is even more serious when using inks based on organic solvents because they posses a high fluidity and expand very rapidly.

One remedy for reducing the “dot gain” is an enhanced absorption of the ink into the imprinted substrate so that it cannot expand on the surface. In this respect it is known to use inks that partly dissolve the surface of the polymeric substrate. If the polymeric film is made from PVC (polyvinylchloride), inks comprising ketones like methyl ethyl ketone or cyclohexanone lead to a rapid swelling of the surface of the PVC, which enhances their absorption. Such inks are unfavourable because their vapour is toxic. Their use necessitates a recovering and systems for protection and ventilation which are costly.

It is further known to admix additives to the polymeric base of the film which enhance absorption. DE 199 43 339 (Renolit Werke GmbH) describes a method for inkjet printing with films that contain cellulose esters with acetyl, propionyl or butyryl groups. Those known methods necessitate significant amounts of additive (10-20%) which increase the price of the film.

Other proposals include a method of enhancing resolution in inkjet printing of organic based ink on films from a composition containing a polyvinyl chloride as polymeric base by admixing a polymer comprising vinyl acetate groups in unpublished European Patent application No 07012057 or a process for improving the resolution of inkjet printing of polymer films comprising a base polymer according to which a copolymer additive comprising a polymer group A and a polymer group B is blended with the base polymer, group A having a lower surface tension than that of the base polymer and group B being compatible with the base polymer in WO 2007/048548 A1.

On the other hand, for printing of expanded uni coloured areas a high spreading rate/low resolution would be favourable, so that a uniform impression is obtained.

The present invention has set itself the object to provide films that can be imprinted with controllable resolution by inkjet printing without being costly and without the use of toxic solvents.

This object is solved by providing PVC films as substrate for inkjet printing containing a filler coated with a polysiloxane and/or adding a polysiloxane in combination with a specific setting of the temperature within the embossing step to a higher temperature for low resolution and to a lower temperature for high resolution. It has been found that this admixture together with adjusting the embossing temperature allows to control resolution.

Therefore the present invention relates to a method of manufacturing high resolution films as substrate in inkjet printing from a composition containing a polyvinyl chloride as polymeric base by admixing a filler coated with a polysiloxane and/or a polysiloxane wherein the composition is manufactured into a film and the film is embossed whereby the film temperature during embossing is set to not more than 70° C. The invention also provides a method of manufacturing films as substrate in inkjet printing of large areas with uniform colour from a composition containing a polyvinyl chloride as polymeric base wherein the composition is manufactured into a film and the film is embossed whereby the film temperature during embossing is set to at least 70° C. The invention further provides films as substrate for inkjet printing with a controllable resolution made from a composition comprising a polyvinyl chloride as polymeric base and a filler coated with a polysiloxane and/or polysiloxane wherein the composition is manufactured into a film and the film is embossed whereby the film temperature during embossing is set to not more than 70° C. for high resolution and to at least 70° C. for printing large areas in uniform colour.

The method and films of the invention are particularly suitable for organic based inks. The term organic based inks means that the solvent for the dying substances (dyes and/or pigments) is not pure water or predominantly water. Examples are the Eco-Sol inks from ROLAND and solvent inks from Mimaki.

The term film as used herein designates a flat product with a thickness in one dimension at least 100 fold preferably at least 1000 fold less than in its other two dimensions. Typically the films according to the invention have a thickness from 50 to 250 μm and preferably from 70 to 120 μm, a width from 10 to 250 cm and a length from 10 to 10.000 m. Advantageously the films are handled rolled up. They are manufactured in a manner known per se by extrusion or preferably by calendaring from a composition comprising a polymeric base which preferably makes up at least 40% by weight, more preferably at least 50% by weight and especially preferred at least 60% by weight of the composition. Other components may be: secondary polymers, several additives like stabilizers, plasticisers, pigments, or filling materials like e.g. silica, calcium carbonate.

The term films as used herein also comprises laminates of two, three or more layers, provided the layer to be printed on has a composition according to the invention. The layers may be joint by any method known in the art, e.g. they may be co-extruded or connected by adhesives or adhesive intermediate layers.

The polymeric base is chosen according to the intended application of the imprinted film. It is preferred that the polymeric base is a vinyl chloride homo-polymer, but it is also possible that the polymeric base is a copolymer of vinyl chloride with e.g. vinyl acetate or acrylic acid esters (butyl acrylate for instance). The amount of comonomers if any ranges preferably from 5 to 30%. The weight average molecular weight (Mw) of the polymeric base ranges typically from 50.000 to 300.000 g/mol, preferably from 80.000 to 200.000 g/mol. It is possible to use a mixture of two or more different polyvinyl chlorides, e.g. a homopolymer and a copolymer or two polymers with differing molecular weight.

According to the invention the composition for manufacturing the film comprises a filler coated with a polysiloxane and/or a polysiloxane. The filler is preferably titandioxide. Titandioxide is preferred due to its superior opacity and whiteness, providing, inter alia, an excellent weathering stability to the pigmented film. Fillers useful according to the invention are e.g. TiO2 R 105 from DuPont and Kronos 2220 and 2211 and Kemira 405.

As an alternative or in addition to using a coated filler the polysiloxane may be added as such.

The polysiloxane is in all embodiments a compound of the formula:

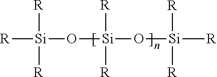

wherein the residues R may be the same or different and are chosen from alkyl, aryl, alkylaryl, alkenyl and alkinyl which may be substituted by e.g. alkyl, alkoxy, acyl and other groups. Preferably the residues are alkyl, especially preferred lower alkyl like methyl, ethyl, i-propyl, n-propyl, i-butyl, n-butyl or tert-butyl. The currently most preferred material is poly(dimethylsiloxane). The amount of n is chosen such that the number average molecular weight (Mn) ranges from 1.000 to 50.000 g/mol, preferably from 5.000 to 30.000 g/mol. The molecular weight is determined by HPLC.

The amount of filler coated with polysiloxan ranges from 5 to 40 parts per 100 parts of polymeric base (phr), preferably 10 to 30 phr. With less than 10 phr the effect is limited, more than 30 phr causes difficulties with calendering the film. The amount of polysiloxane coating can vary from 0.1% to 1%, preferably from 0.3 to 0.7% by weight of the filler.

The filler may be added in any manner known as such. In a preferred embodiment the filler is added in the form of a paste, usually obtained by dissolving with plasticizer and dispersing over a roll mill. In this way the polysiloxane coating (initially physisorbed to the filler) desorbs easier and so is more available for migration (blooming) to the surface and further lateral spreading. It is also better dispersed. If polysiloxane is added as such to the composition there are generally 0.01 to 0.5 phr of polysiloxane added, preferably 0.05 to 0.1 phr.

For high resolution printing, the films shall have an amount of atomic Si from the polysiloxane at the surface of the film (that is in its upper 10 nm) as measured by X-ray induced photoelectron spectroscopy (XPS) of from 0.5 to 5 Atomic %, preferably of from 0.8 to 3 Atomic %. XPS is a form of electron spectroscopy in which a sample is irradiated with a beam of monochromatic X-rays and the energies of the resulting photoelectrons are measured. This method is also known as electron spectroscopy for chemical analysis (ESCA).

For printing large areas with uniform colours the films shall have an amount of atomic Si from the polysiloxane at the surface of the film (=upper 10 nm) as measured by XPS of below 0.5% Atomic %, preferably of below 0.4% Atomic %.

The use of coated fillers is known to facilitate dispersion of the filler in the polymeric base and also dusting of the filler during handling is reduced. However, it was very surprising that the coating has an influence on the resolution when using the films as substrate in inkjet printing.

The composition may additionally comprise one or more usual additives.

Preferred are stabilizers, e.g. thermal stabilizers such as carboxylic fatty acid salts of barium, calcium or zinc, like zinc oleates or barium tertiary butyl benzoates, or tin mercaptides. They may be present in an amount from 1 to 3%.

Further preferred are processing aids such as copolymers based on acrylic acid esters (butyl acrylate, methyl(meth)acrylate) and also styrene or butadiene. They may be present in an amount from 1 to 3%.

Further preferred are plasticisers in an amount of from 5 to 50 parts per 100 parts polymeric base. Plasticisers are preferably added in an amount of from 10 to 30 parts per 100 parts polymeric base. All known plasticizers are suitable. Especially preferred are monomeric plasticizers like Di-iso-decylphthalate (DIDP), Di-2-Hexyl-phthtalate (DOP), Di-iso-nonyl-cyclohexane-1,2-dicarboxylate (DINCH) and polymeric plasticizers like adipic acid polyester.

A typical PVC film for inkjet printing, that is also suitable according to the present invention, comprises:

| | | |
|---|---|---|
| PVC (polymeric base) | 100 | parts |
| Plasticiser (monomeric) | 20 to 30 | parts |
| Plasticiser (polymeric) | 20 to 30 | parts |
| epoxidized soy bean oil | 2 | parts |
| thermal stabiliser | 3 | parts |
| processing aid | 2 | parts |
| TiO₂ | 5 to 40 | parts |

Other additives, e.g. pigments for adjusting the colour of the film, may be present in minor amounts, i.e. less than 1 part.

The methods according to the invention are based on the finding that with embossed films the resolution depends on the film temperature used in the embossing. The resolution is high, i.e. dot gain<3, with lower temperatures of up to 40° C., or up to 50° C. or up to 60° C. and not more than 70° C., preferably not more than 65° C. On the other hand, it may be preferred to have a film that allows uniform printing of large areas with one colour, in this case a high resolution would lead to visible stripes. For this kind of application, the film temperature during embossing should be set high, like at least 70° C., preferably at least 75° C. and even at least 80° C.

The main advantages of the method according to the invention are that:

1) with one and the same composition it is possible to produce “high resolution” films and “low resolution” films as substrate for inkjet printing by changing the embossing temperature and
2) by producing with the same embossing temperature (high), it is possible to switch from “low resolution” films to “high resolution” films by addition of PDMS to the formulation either as coating on the filler or as an additive.

The first step of the method according to the invention is manufacturing of a film from at least a polymeric base and a filler. The film may be manufactured according to any known method, preferably it is made by calendering. The method of calendering is known to the man skilled in the art.

The next step is an embossing step as is usual for films intended for inkjet printing. This step is the essential one for the invention. By adjusting the temperature during embossing the resolution during inkjet printing is controlled. The embossing usually takes place immediately after manufacturing the film, and this is also the preferred mode according to the invention. However, it is contemplated that it is possible to reheat a film and perform the embossing off-line. According to the invention there is a specific setting of the temperature during embossing adapted to the intended resolution.

The method of the invention shall be illustrated with reference to the attached figures, in which:

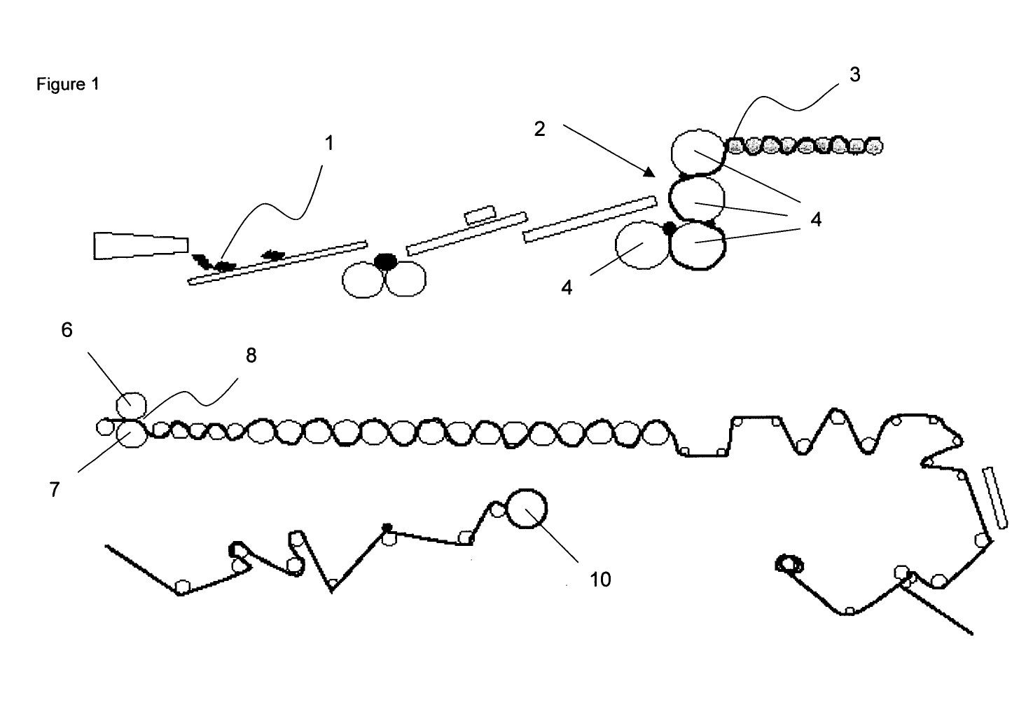

FIG. 1 shows one example of a production line and

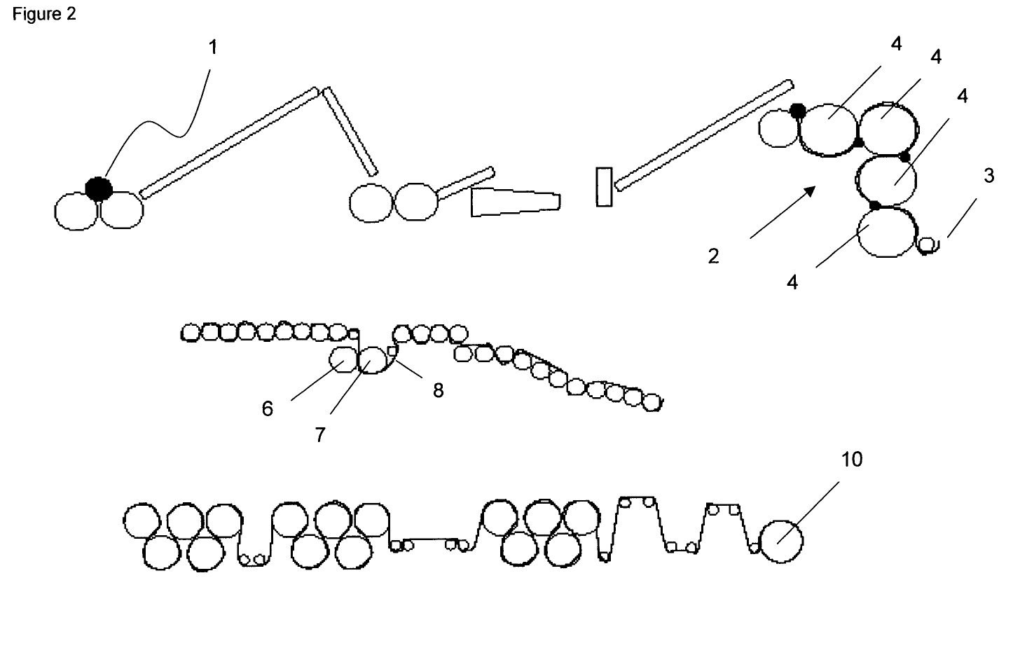

FIG. 2 shows an example of an alternative production line.

The equipment is shown schematically. In both cases the composition 1 mixed from the components is supplied to a calender 2. The calender 2 forms a primary film 3 from the composition, usually via four or five rolls 4. The primary film 3 is then passed on to an embossing section 5 via rolls where a first set of rolls 6, 7 imparts an embossing pattern onto the film 3 providing the film 8 according to the invention. This is then passed over a set of further rolls to a winding station 10.

The temperature to be controlled according to the method of the invention is that of the film 3 passing the first set of rolls 6,7.

The temperature of the film during embossing is influenced by the temperature of the film 3 as it enters the embossing section and by the temperature setting of the embossing rolls 6,7. The film temperature can be determined e.g. by an infrared based measuring device known as such. Once the film temperature for specific conditions as specified is measured, further measuring of its temperature during the continuing production is not necessary.

The invention will be further illustrated by the following examples without restricting the scope to the specific embodiments described. If not explicitly stated otherwise, all parts are by weight and all % are by weight of the total composition.

### EXAMPLE 1

Films for inkjet printing were manufactured containing the substances as stated in the following table 1:

| component | Parts |
|---|---|
| PVC K-64 | 100 |
| Acrylic processing aid | 2 |
| Di-2-hexylphtalathe DOP | 23 |
| Epoxidised soya bean oil | 2 |
| Barium zinc thermal stabilizer | 3 |
| Siliciumdioxide | 0.3 |
| Titandioxide Kronos 2220 | 11 |
| Carbonblack Printex 300 | 0.01 |
| Blue pigment violetmanganese VM 40 | 0.03 |
| Optical brightener Uvitex OB 10% | 0.5 |
| polydimethylsiloxane | 0-0.1 |

TiO₂ was a coated filler with a particle size of 250 μm and a coating of 0.5% by weight polydimethylsiloxane. In some films a polydimethylsiloxane with a molecular weight of 8000 g/mol was added.

The components of the formulation were mixed together in a compound mixer with the temperature rising up to 50° C. with friction. The mixture is fed to the extrusion device at about 160° C., plasticized material is transported in a roll mill at 160° C. A strip is taken from the homogenous composition to feed the nip of a calender with the following roll-temperatures: roll 1=165° C., roll 2=166° C., roll 3=211° C., roll 4=169° C. The primary film passes stripper rollers at 172° C. and then an embossing unit at the selected temperature to provide the intended surface of the film. The film is then tempered before winding it in a roll.

Films have been made with the amount of polysiloxane and with the temperatures according to the following table 2:

| | | Embossing | Measured film |
|---|---|---|---|
| | added poly- | temperature | temperature during |
| film | siloxane [phr] | setting [° C.] | embossing [° C.] |
| E1a | 0 | 37 | 60 |
| E1b | 0 | 37 | 60 |
| E2 | 0 | 60 | 80 |
| E3 | 0 | 40 | 65 |
| E4 | 0.05 | 85 | 100 |
| E5 | 0.05 | 60 | 80 |
| E6 | 0.05 | 40 | 65 |
| E7 | 0.1 | 85 | 100 |
| E8 | 0.1 | 40 | 65 |
| E9 | 0 | 85 | 100 |

The resolution test is based on the measurement of the diameter of droplets. A lower rate of flowing will lead to a smaller diameter of the droplets and their spreading. For this test PVC-films with the compositions of table 1 have been made and ink is applied via inkjet printing with the droplet diameter adjusted to 35 μm. This corresponds to an intended surface of 994.15 μm². After drying the printed dots have a diameter D and a surface S which are measured. One calculates two parameters, the spreading ratio corresponding to the ratio between the measured surface S and the initial intended surface of 994.15 μm² and the dot gain which corresponds to the ratio between the diameter of the dot as measured and the droplet diameter of 35 μm. The results are summarized in the following table 3.

| | Average dot | Ratio droplet/ | Dot diameter | |
|---|---|---|---|---|
| film | size [μm²] | 994.15 μm² | [μm] | Dot gain |
| E1a | 8370 | 8.4 | 103 | 2.9 |
| E1b | 8540 | 8.6 | 104 | 2.9 |
| E2 | 9000 | 90 | 107 | 3.0 |
| E3 | 8580 | 8.6 | 105 | 2.95 |
| E4 | 10730 | 10.8 | 117 | 3.3 |
| E5 | 8770 | 8.8 | 106 | 3.0 |
| E6 | 6280 | 6.3 | 89 | 2.5 |
| E7 | 9860 | 9.9 | 112 | 3.15 |
| E8 | 4910 | 4.9 | 79 | 2.2 |
| E9 | 12570 | 12.6 | 127 | 3.6 |

The measurements show that the dot gain and thus resolution can be high when the film temperature during embossing is set to lower than 70° C. or low when the film temperature is set to more than 70° C. Further, the resolution is clearly adjusted by changing the embossing temperature, i.e. starting with a temperature of 60° C. the dot gain is 2.9, at 65° C. it is 2.95 and at 80° C. it reaches 3.0 the limit of low resolution. Thus, according to the invention it is possible to produce films with a desired high or low resolution during ink jet printing without changing the composition as is necessary for the prior art approaches that add substances to improve resolution. It is important to observe the two parameters, film temperature and polysiloxane as present due to a coating of the filler and/or due to addition as a substance. However, as compared to the previously used additions the amount of added substance can be lowered.

### EXAMPLE 2

Further films were made from the composition as described in table 4.

| component | Parts |
|---|---|
| PVC K-64 | 100 |
| Acrylic processing aid | 1.9 |
| Di-2-hexylphtalathe DOP | 21.45 |
| Epoxidised soya bean oil | 3.55 |
| BaZn thermal stabilizer | 3.17 |
| Blue pigment | 0.016 |
| Titandioxide Kronos 2220 | 13.26 |
| Optical brightener Uvitex OB 10% | 0.70 |
| caprolactonesiloxane | 0-0.51 |

The TiO₂ was used with and without coating.

The films were made by mixing of the formulation components. The mixture is plasticised on a laboratory roll mill (2 rolls) at about 180-185° C., in a first step with low speed of rolls until a rough sheet arises on the roll. The film is homogenised by increasing of roll speed to 12 m/min with different friction of the rolls. After about 10 min. the film can be taken from the front roll and pulled over a transport belt with an appropriate thickness at a speed of 6 m/min. Afterwards the films are thermally laminated on a lab-press to achieve an even surface for the inkjet printability test.

The resolution during inkjet printing has been determined as above. The results are listed in table 5.

| | | Added | | | | |
|---|---|---|---|---|---|---|
| | | poly- | Average | Ratio | Dot | |
| | | siloxane | dot | droplet/ | diameter | Dot |
| film | TiO₂ | [phr] | size [μm²] | 994.15 μm² | [μm] | gain |
| E 10 | coated | 0 | 13716 | 13.80 | 132.15 | 3.71 |
| E 11 | uncoated | 0 | 16559 | 16.66 | 145.20 | 4.08 |
| E 12 | uncoated | 0.254 | 7575 | 7.62 | 98.20 | 2.76 |

It can be seen that with the coating and with the addition of polysiloxane the resolution is enhanced. Since the processing conditions during manufacture correspond to a high temperature during embossing high resolution can only be achieved by a massive addition of polysiloxane. The coating on the filler that is fully sufficient when a controlled embossing step is performed will not provide enough Si atoms at the surface in this case.

1. Method of manufacturing high resolution films as substrate in inkjet printing from a composition containing a polyvinyl chloride as polymeric base comprising the steps of manufacturing a film from the composition and embossing the film characterized in that a filler coated with a polysiloxane and/or a polysiloxane is admixed to the composition and the film temperature during embossing is set to not more than 70° C.

2. Method according to claim 1, characterized in that the film temperature during embossing is set to not more than 65° C., preferably to not more than 60° C.

3. Method according to claim 1 or 2, characterized in that the film is manufactured by calendering.

4. Method of manufacturing films as substrate in inkjet printing of large areas with uniform colour from a composition containing a polyvinyl chloride as polymeric base comprising the steps of manufacturing a film from the composition and embossing the film characterized in that the film temperature during embossing is set to at least 70° C.

5. Method according to claim 4, characterized in that the film temperature during embossing is set to at least 80° C.

6. Method according to claim 4 or 5, characterized in that the film is manufactured by calendering.

7. Films as substrate for inkjet printing made from a composition comprising a polyvinyl chloride as polymeric base characterized in that the composition comprises a filler coated with a polysiloxane and/or a polysiloxane and the composition is manufactured into a film, the film is embossed and the film temperature during embossing is set to not more than 70° C. for high resolution and to at least 70° C. for printing large areas in uniform colour.

8. Films according to claim 7, characterized in that the polysiloxane is a polydimethylsiloxane.

9. Films according to claim 7 or 8, characterized in that the filler is TiO₂ coated with polysiloxane and is present in an amount of from 10 to 30 phr.

10. Films according to any one of claims 7 to 9, characterized in that the polymeric base is selected from vinylchloride homopolymers and vinyl chloride copolymers.

11. Films according to any one of claims 7 to 10, characterized in that the composition additionally contains common additives.
